(19) United States
(12) Patent Application Publication
(10) Pub. No.: US 2015/0334101 A1
(43) Pub. Date: Nov. 19, 2015

(54) Aggregator of Media Content

(71) Applicant: Danke Games Inc., Heidelberg (DE)

(72) Inventors: Simon Brüchner, Heidelberg (DE); Dan Kelly, Baton Rouge, LA (US); Fraser Ross MacInnes, Karlsruhe (DE)

(21) Appl. No.: 14/712,700

(22) Filed: May 14, 2015

Related U.S. Application Data
(60) Provisional application No. 61/996,780, filed on May 14, 2014.

(51) Int. Cl. H04L 29/06; G06F 17/30; G06F 3/0482

(52) U.S. Cl. CPC H04L 63/08; G06F 3/0482; G06F 17/30424; G06F 17/30312

(57) ABSTRACT

A media content aggregation system retrieves media content from a user's device or off-device media server and services accessible by the user and organizes the retrieved media content into a media content list. A user can filter and/or select various content items from the media content list and store the selected items in a media collection. The aggregation system is configured to parse and optimize the content items for completeness and optimal display on specified devices in addition to optimizing the media content list for display. The user can select the content items from this list with one click before assembling a collection. The media content aggregation system is configured to handle and store authentication information from the media server or services to obtain access to their media content and communicates a media content application that provides a user interface to a user on a client device.

### CROSS REFERENCE TO RELATED APPLICATIONS

The application claims the benefit of Provisional Application No. 61/996,780, filed on May 14, 2014, the content of which is incorporated herein by reference.

### FIELD OF THE DISCLOSURE

This disclosure relates to systems that aggregate media content from a user's device or off-device media content servers into a media content list, and in particular, that selects content from the media content list for grouping into collections that can be stored, displayed and edited on various devices.

### BACKGROUND

People are at an increasing rate creating digital content and share this content with friends and others through various forms of social media and online services. People for example share personal content and updates on social networking sites, post messages to messaging servers or share their photos through the image publishing services. With an ever-increasing amount of content being created and an increasing number of services used for sharing content, it becomes more difficult for a user to later retrieve such content and readily access from and display content on various sources. Additionally, media servers or services often reformat media content for their own purposes in a manner that is not optimal for the usage of that content on devices that cannot process the formats provided by the media servers or services.

### BRIEF DESCRIPTION OF THE DRAWINGS

FIG. 1 is a diagram illustrating a computing environment configured for aggregating media content into a media content list, according to some embodiments.

FIG. 2 is a diagram illustrating the system architecture of a media content aggregation system combining or aggregating media content into a media content list that is presented to a user through a user interface, according to some embodiments.

FIG. 3A-D are user interfaces presenting a media content list comprising content items from one or more media servers or services to a user for selection, according to some embodiments.

FIG. 4 is a flow diagram illustrating an authentication method of a media server or service with a media content aggregation system, according to some embodiments.

FIG. 5 is a flow diagram illustrating an authentication method of a media server or service with a media content aggregation system, according to some embodiments.

FIG. 6 illustrates embodiments of components of an example machine able to read instructions from a machine-readable medium and execute them in a processor (or controller).

The figures depict various embodiments for purposes of illustration only. The features and advantages described in following detailed description are not all-inclusive. Many additional features and advantages will be apparent to one of ordinary skill in the art in view of the drawings, and specification hereof.

### DETAILED DESCRIPTION

### Configuration Overview

A media content aggregation system and method combines a user's content items from a plurality of media content servers into an ordered and formatted media collection. One embodiment of the media content aggregation system and method comprises: receiving a plurality of content items from a plurality of media content servers; filtering content items based on user-defined filter criteria; combining the filtered content items into a media content list; displaying the media content list for selecting one or more content items of the media content list; selecting one or more content items form the displayed media content list; generating a media collection including the one or more selected content items; and formatting the media collection for displaying on one or more user-defined electronic devices.

Another embodiment of the media content aggregation system and method comprises: receiving a media content list comprising content items, the content items being received from a plurality of media servers and filtered based on a user-defined filter criteria; displaying the media content list through a user interface for selecting content items from the media content list to create a media collection; selecting a content item from the media content list in order by clicking on the content item; and transmitting an ordered selection of content items in response to interacting with the user interface, the ordered selection comprising the selecting content item in the order the content item was selected.

In some embodiments, the media collection of content items generated by the media content aggregation system is shared among different users in an integrated form. This integrated form allows displaying the media collection within a web page without further requiring further editing of the content items. For example, media collections are integrated into a user's FACEBOOK timeline or a payment gateway of an internet payment provider. In other example, the media content aggregation system is used to create media collection including products and advertisement that is easily integrated into the website of an online shop or into the listings for an online auction website. The advantage of using the media content aggregation system to generate media collections or ordered selections of media content includes ease of use, speed to generate, and being able to aggregate media content in various formats from a variety of media servers and services without the need to separately manage the media content on each media server or service.

### Media Stream Aggregation System

Some embodiments of a media content aggregation system provide a method for a user to create a collection of media content that the user or other persons previously posted on media servers or services. Each media content represents a content item retrievable from the media server or service. Examples of such media content include images of social events uploaded by a user to a media server or service. Other examples are text messages posted by the user to a messaging server. Additional examples of social media content, e.g., photos, digital audio and video, are described in more detail below. Posting content on media servers or services, (e.g., social networking system, image publishing service providers, text and voice messaging communication services), often leads to the difficulty for the user to later locate and access the content. In addition, distributing the content among different media servers or services has the disadvantage of requiring a user to individually log into the server account before retrieving the content from the media server or service. Furthermore, a user may have separated and dispersed content items that are related to each other over various distinct media servers or services. In addition, multiple versions of the content item may exist on the same or different media servers or services because of the service provider, which manages the media server or service that hosts the content, repeatedly processing the content due to version updates of the media server or service. The media servers or services oftentimes fail to provide download options of the content suitable for a particular user. The media content aggregation system is configured to address these and other difficulties that a user experiences when managing their media content of various formats and types and across various platforms of media server or service.

Some embodiments of the media content aggregation system provide a method of retrieving media content from multiple media servers or services, and combining or aggregating the retrieved content into a single media content list. In some embodiments, a media content list includes media content from one or more media content streams or feeds. In case of the media content list including media content from streams, the media content list is optionally labelled “My Streams” when displayed through a user interface on a client device. In some embodiments, the media content aggregation systems generates one or more media content lists based on the type and/or format of the retrieved media content. In some embodiments, the user specifies which media servers or services to access and from which to retrieve media content. The aggregation system is configured to query a media server or service for media content that a particular user has access to and to obtain access to the content. To facilitate a user in specifying the media servers or services that the aggregation system queries for user content, the aggregation system displays to the user a pre-defined list of media servers or services, from which the user can select one or more servers or services. In some embodiments, the user adds (lists) or deletes (unlists) media server or services from the pre-defined list.

After retrieving media content from multiple servers, the media content aggregation system includes the content in a media content list. The aggregation system is configured to retrieve a format of the content suitable for a media content list. In some embodiments, the aggregation system optimizes the retrieved format for one or more devices used for storing, editing, or displaying the media content list. In another embodiment, the aggregation system may provide the user with a list of media content that is associated with the user and available for retrieval from the pre-defined or user-selected media servers or services. The aggregation system is further configured for the user to select which media content to retrieve and combine as well as the format used by the system in combining the retrieved content. In some embodiments, the format options shown by the aggregation system depend on the device that the user uses to display or export the media content list to. The aggregation system may determine the type of device that the user uses to communicate with the aggregation system, and upon determining the device type provide the user with particular format options. Alternatively, the aggregation system may provide a user interface that is configured for inputting a plurality of device types for displaying the media content list.

In some embodiments, a media collection of content items generated by the media content aggregation system is shared among different users in an integrated form. This integrated form allows displaying the media collection within a web page without further requiring further editing of the content items. For example, media collections are integrated into a user's FACEBOOK timeline or a payment gateway of an internet payment provider. In other example, the media content aggregation system is used to create media collection including products and advertisement that is easily integrated into the website of an online shop or into the listings for an online auction website. The advantage of using the media content aggregation system to generate media collections or ordered selections of media content includes ease of use, speed to generate, and being able to aggregate media content in various formats from a variety of media servers and services without the need to separately manage the media content on each media server or service.

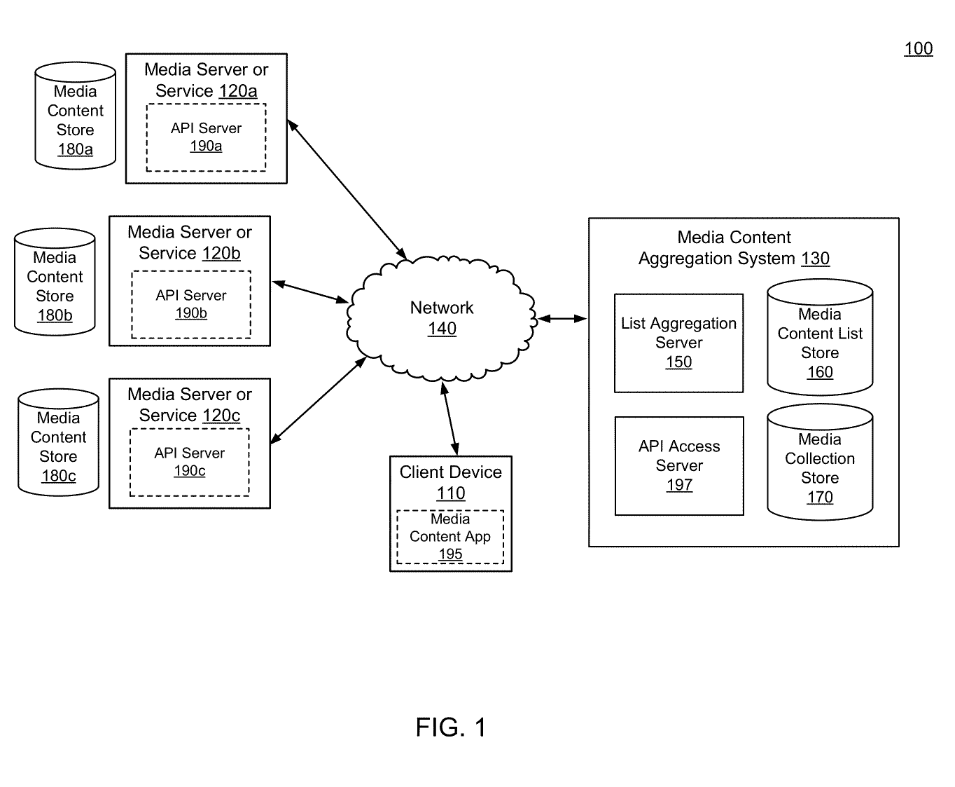

FIG. 1 illustrates a computing environment 100 configured for aggregating media content into a media content list, according to some embodiments. The computing environment 100 comprises multiple computing systems, including a user's client device 110, media servers or services 120, and a media content aggregation system 130, all communicatively coupled through a communications network 140 (e.g., the internet). The communications network 140 may comprise any combination of local area and/or wide area networks, using both wired and wireless communication systems, configured to communicate social media content between the computing systems. For example, the computing systems may be programmed to communicate with each other using a networking protocol such as transmission control protocol/internet protocol (e.g., TCP/IP and HTTP). In one embodiment, the media content aggregation system 130 accesses social media content from a media server or service 120 through the network 140.

In some embodiments, the client device 110 comprises a computing system that can receive user input and can transmit and receive data via the network 140. For example, the client device 110 may be a desktop computer, a laptop computer, a smart phone, a personal digital assistant (PDA), or any other device including computing functionality and data communication capabilities. The client device 110 is configured to communicate via network 140. Typically, a computing system includes one or more processors, memory (volatile or non-volatile, e.g. hard disk drives), a display and input devices such as a keyboard, a mouse or a touchscreen. The client device 110 processes a user's input and accesses the aggregation system 130 for either providing information or retrieving information. For example, information may include an authentication token that allows the aggregation system to be authenticated with a particular media server or service associated with the authentication token.

In some embodiments, the media content aggregation system 130 includes a list aggregation server 150, a media content list store 160, and a media collection store 170. In other embodiments, the media content aggregation system 130 may include additional, fewer, or different modules for various applications. Conventional components such as network interfaces, security mechanisms, load balancers, failover servers, management and network operations consoles, and the like are not shown to not obscure the details of the system. The list aggregation server 150 may communicate with a media server or service 120 and retrieve media content available from the media server or service 120. A user may have provided media content to a particular media server or service 120 at an earlier time. The user may also have access to media content provided by third parties, e.g. friends of the user, to a media server or service 120. In some embodiments, a media server or service 120 then archives the content in a media content store 180 for later access and retrieval by the user or third parties. Such content includes images, text, pictorial data, and metadata, e.g., the user's identity, a content title, the time and date when the content was posted to the server, a brief description of the content, its locator (e.g., a Uniform Resource Locator (URL)), and geographic location information, among other content items.

### Social Media Content

A media content list is a collection of content items that are provided by the list aggregation server 150, according to some embodiments. Similar to content items provided by a media server or service 120, a content item in a media content list includes, but is not limited to the item's actual content (e.g., images, text or pictorial data), a content title, for example, a headline, a description of the content, content location information (e.g., URL or simple text), other metadata, or any combination thereof. For example, if the content item identifies text, the content item may include text itself inline, along with the title for headline) descriptive of the text, and the item's locator. A content item may also include a link (e.g., URL) to another third-party piece of content. The actual content of a content em may be any machine-readable data, including but not limited to text, images, digital audio, digital video, Portable Document Format (PDF) documents, and so forth. Content accessible from a media server or service 120 and associated with a particular user may contain a plurality of content items. In one embodiment, the media content aggregation system 130 provides a user with a list of content items that are available from pre-defined or user-selected media servers or services 120 and that are associated with the user or a third party granting the user access to these items. The media content aggregation system 130 may filter the content items before including the items in the user-provided list. This filter is optionally based on a date and time associated a content item, the media server or service that the content item is located at, other characteristics of the content item or any combination thereof. Filter criteria further include the type of the client device 110 used for displaying the media content list. In some embodiments, the user specifies filter criteria that the media content aggregation system 130 uses for filtering content items retrieved from the media servers or services 120. Filter criteria include, but are not limited to, the format, type, and size of the media content, the media server or service, from where the media content is retrieved, or any combinations thereof. For example, only FACEBOOK images dated from the year 2014 are not filtered based on the filter criteria. In some embodiments, filter criteria are set to allow retrieval of media content that is linked on web pages that are accessed by the media content aggregation system 130. For example, text messages such as tweets may contain links to images hosted on servers different from the media server or service 120 providing the text message. In this case the media server or service 120 provides an external URL pointing to media content and embeds the URL, for example, in a text message that the media content aggregation system 130 then uses to retrieve the media content from another third party source, to which the URL points, and to provide this media content to the user.

### System Architecture

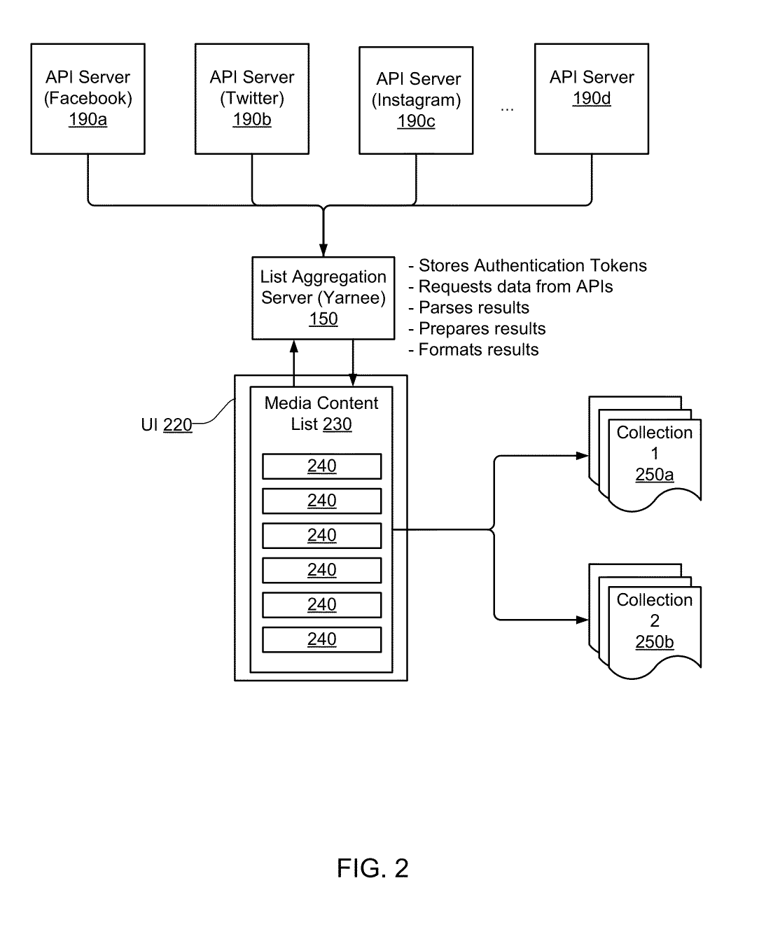

FIG. 2 illustrates the architecture of a media content aggregation system 130 combining or aggregating media content into a media content list 230 that is presented to the user through a user interface (UI) 220, according to some embodiments. The media content aggregation system 130 offers its user the ability to communicate and interact with media servers or services 120. A user of the media content aggregation system can be a user of one or more media servers or services 120.

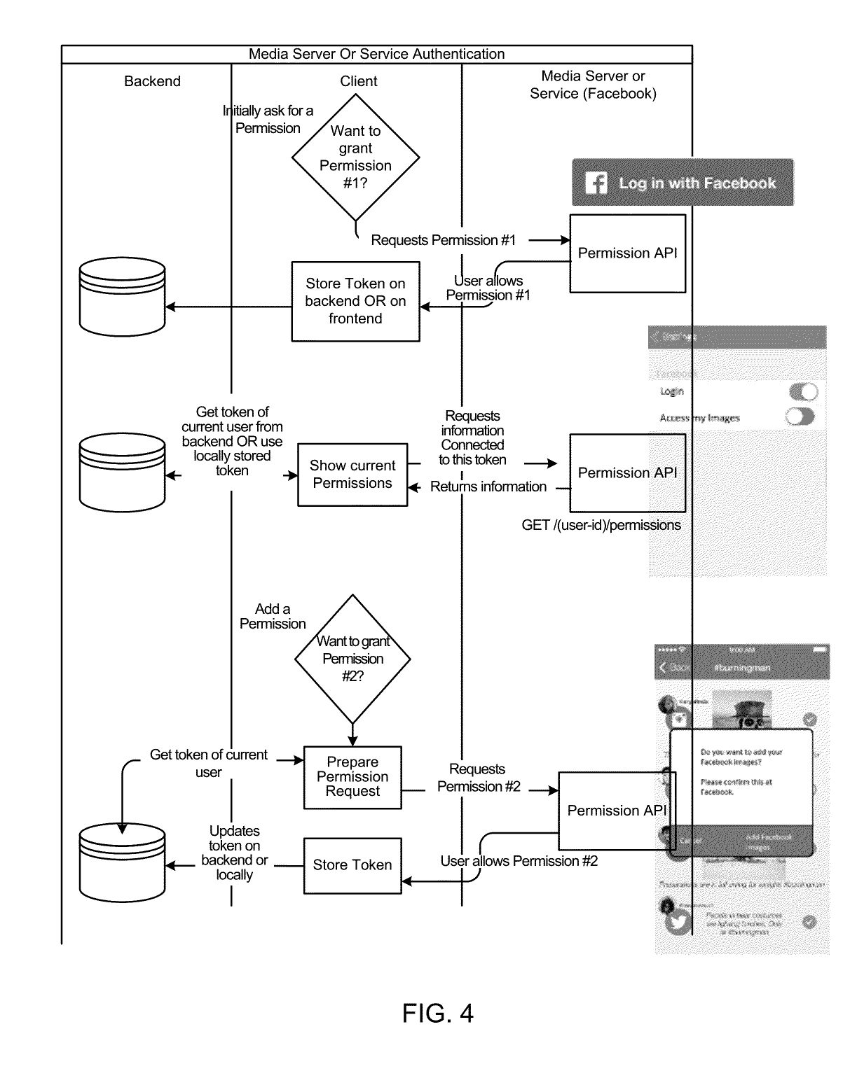

The media content aggregation system 130 may access information and media content from a media server or service using an Application Programming Interface (API) associated with or provided by an API server 170 or by using another methodology (e.g., RSS, crawling) that interfaces with the media server or service. In some embodiments, the aggregation system 130 sends a markup language document to the client device 110 with instructions for interacting with a particular media server or service 120. The media content aggregation system 130 optionally uses information obtained from the user about a media server or service 120 for various purposes, e.g., authentication with a media server or service that provides media content of a user. Upon authentication with a media server or service 120, the list aggregation server 150 may store a token associated with the media server or service in its media content list store 160, as described in more detail in FIG. 4. In some embodiments, the list aggregation server 150 requests media content provided by the media server or service 120 using the API provided by an API server 190.

The embodiment in FIG. 2 includes API servers 190, an aggregation server 150, and a user interface 220 displaying a media content list 230 that comprises one or more content items 240 of social media. Upon retrieval, the media content list 230 is displayed through a user interface 220 on the client device 110. In some embodiments, the list aggregation server 150 generates collections 250 of content items that are selected by a user from the media content list 230. These collections are optionally stored in the media collection store 170 or the media content list store 160. In some embodiments, the combined media content is stored in the media content list store 160 and retrieved by the user at a later time.

In some embodiments, the list aggregation server 150 maintains information, including tokens, about the API servers 190 provided by the user and/or the API servers. In maintaining the information, the list aggregation server 150 associates the information with a particular user. An API server 190 allows the list aggregation server 150 to access social media content from one or more media servers or services 120 by calling APIs. In some embodiments, an API access server 197 allows the list aggregation server 150 to send information to the media server or service 120 by calling APIs. In some embodiments, the list aggregation server 150 directly sends an API request to the API server 190 via the network 140. The API request is received at the media server or service 120 by the API server 190. The API server 190 processes the request by calling the appropriate program code to collect any appropriate response, which is then communicated back to the list aggregation server 150 via the network 140. In some embodiments, the media server or service 120 receives a request and calls the API server 190 in order to process the request. The information based on the response from the API server 190 is sent in response to the request received by the media server or service 120. In some embodiments, the client device 110 instead of communicating with the API server 190 communicates directly with the media server or service 120 to obtain information. If the API server 190 fails to complete sending the requested information to the list aggregation server, the list aggregation server 150 may send another request to the API server 190 for obtaining the information. In some embodiments, a trigger for another request is initiated after a pre-defined time period has elapsed from the time the first request was sent to the API server 190. Once the trigger is initiated a new request is sent by the list aggregation server 150. In some embodiments, the media content list is cached on a client device 110 to provide a faster user experience.

In some embodiments, this information includes, but is not limited to, the user's credentials with a number of media servers or services and a list of content items from the user's social media content provided by the media servers or services. The information may also include a list of the media servers or services that can provide social media content associated with a particular user. The list aggregation server 150 is configured to sort the list of content items from one or more media server or service 120, including servers with media content from third parties, by date, a limit, geographic location, hashtag, a user-provided search term, face detection, or the media format of the content item. In another embodiment, the list aggregation server 150 eliminates duplicates or copies of similar content items from the media content list 230.

In some embodiments, the client device 110 runs a media content application 195 that sends a request for social media content or authentication information from the client device 110 to an API server 190. Some embodiments use instructions provided in a scripting language that can be executed by the media content application 195 on the client device 110 for sending the request for social media content or for sending authentication information to the media server or service 120. An example of a scripting language includes the JAVASCRIPT language. In some embodiments, the list aggregation server 150 provides the scripting language in form of a code snippet embedded in a markup language document to the media content application 195.

The list aggregation server 150 generates a media content list 230 including the media content received from the API servers 190. To generate the media content list, the list aggregation server may parse content items included in the received media content. In some embodiments, the list aggregation server 150 formats the content items to prepare the media content for display on the client device 110. In another embodiment, the list aggregation server 150 determines the order of the content items in the media content list 230 according to a pre-defined or user-selected priority. For example, content items from particular media servers or services, e.g. FACEBOOK, GOOGLE PLUS, WECHAT, and TWITTER, etc., rank higher in priority than content items from other media servers or services, e.g., INSTAGRAM, BOX or DROPBOX.

### User Interface of Media Content List

A user interacts with the list aggregation server 150 and views a media content list 230 through a user interface (UI) 220 that is presented on a display of a client device 110, according to some embodiments. The UI shows one or more content items 240 of the media content list 230 to the user. In some embodiments, using the UI 220 the user selects particular content items 240 to be included in a collection 250 that comprises a media content list of the selected content items. In some embodiments, the UI 220 is part of the media content application 195 that runs on the client device 110. The media content application 195 is capable to interface with the list aggregation server 150 using an API. In some embodiments, the application 180 transmits a list of the selected content items to the list aggregation server 150. In some embodiments, the list aggregation server 150 stores the transmitted list in the media content list store 160. In some embodiments, the list aggregation server creates a collection comprising a media content of the listed content items and stores the collection in the media content list store 160. In some embodiments, the list 230 and collection 250 of content items is cached locally on the client device 110 and/or stored in media collection store 170.

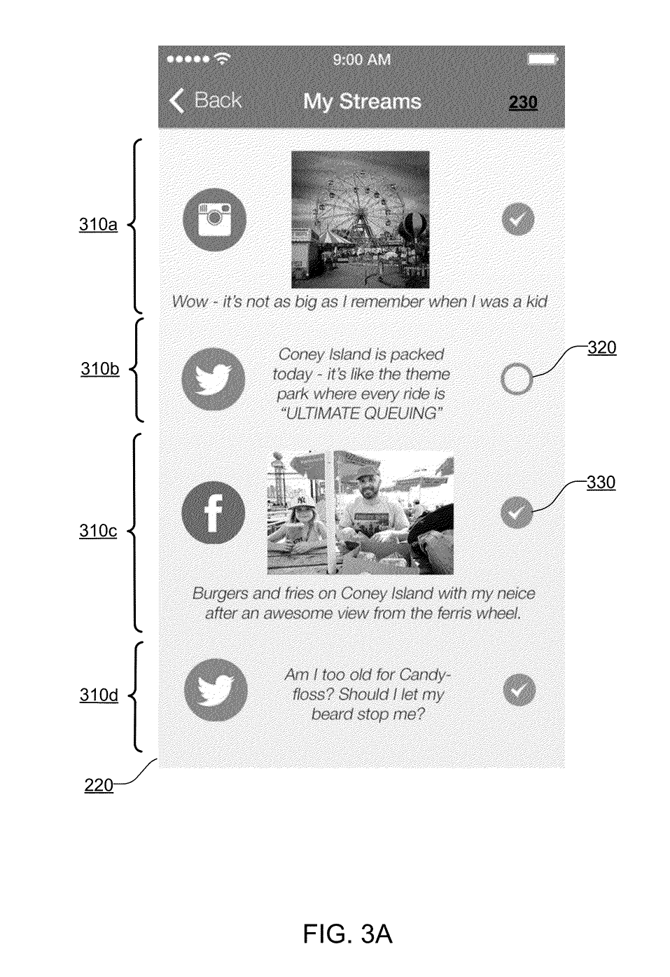

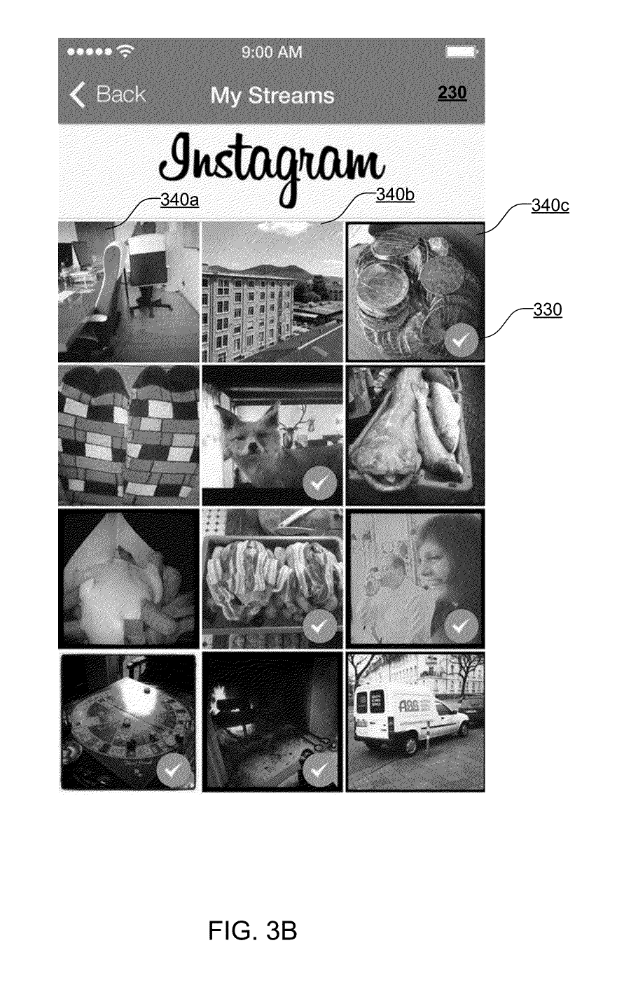

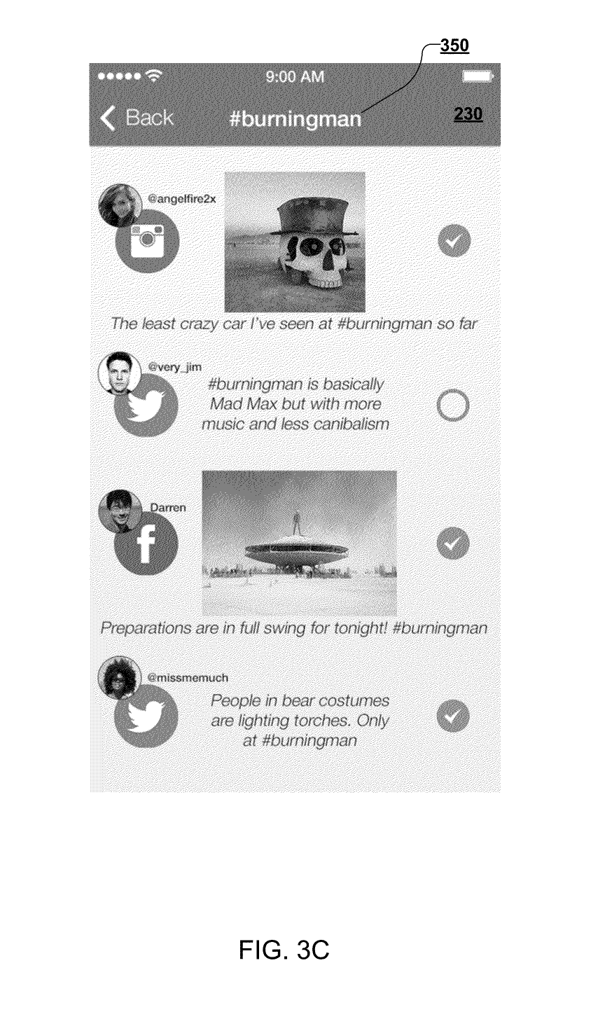

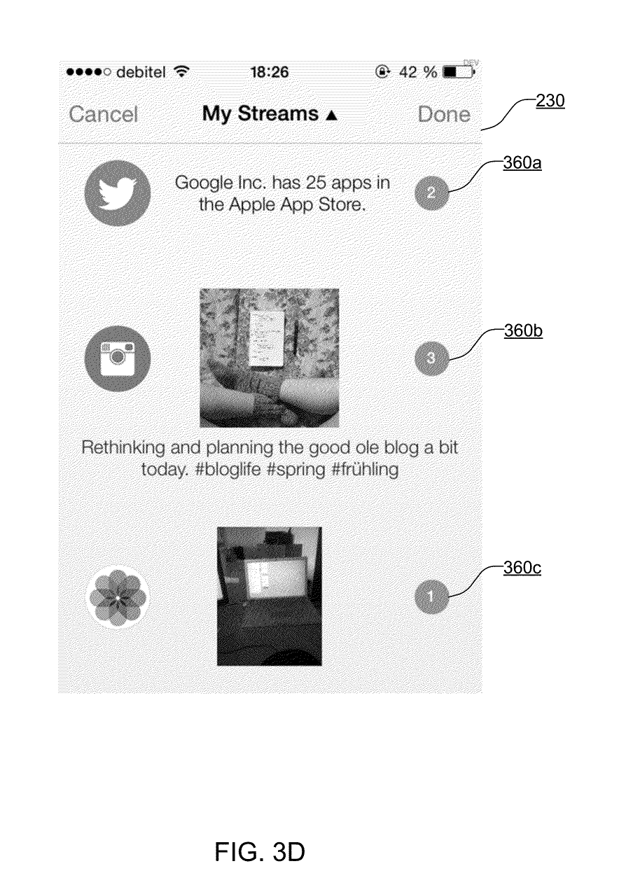

FIG. 3A illustrates the UI 220 that presents a media content list 230 comprising content items 310 from various media server or service to the user for selection, according to some embodiments. In this example, the media content list 230 includes an image and its caption from an image publishing server, two text messages, “tweets,” from TWITTER, a text messaging service, and a FACEBOOK posting including a photo and its caption. In this embodiment, the user can select the content items that are then saved in a collection. Once the user selects the content items and specifies the collection, the collection is stored in the media collection store 170 by media content application running on the client device 110, and communicating the selection through an API to the list aggregation server 150, which then stores the collection in the media collection store 170. The list aggregation server 150 further associates the stored collection with the user so that the stored collection can be later retrieved, displayed, and further manipulated (e.g., edited) by the user or others whom the user grants access to the collection.

In some embodiments, the collection is stored in a format that is independent from the device on which the user performed the selection. This allows for displaying the collection on a wide variety of user devices. When a user later accesses a collection from the media collection store, the collection can be display on a device that is different from the device used to create the collection.

In the media content list 230 of FIG. 3A, a content item occupies a banner-like space 310 spanning the entire display of the device. Each subsequent content item also occupies a banner-like space 310 below the previous content item. The media content list 230 includes for each content item a selection indicator 320 in form of an open circle that is displayed to the right of the web content. Upon selection of a content item by the user, the aggregation system changes the selection indicator to a full circle with a check mark 330.

FIG. 3B illustrates a media content list 230 generated by the media content aggregation system and displayed through the UI 220 on the client device 110, according to some embodiment. The displayed media content list includes images 340 retrieved from a media server or service that operates an image publishing service, e.g. Instagram. The images 340 are optimized by the list aggregation server 150 to be displayed in columns in the UI 220 of the client devices 110. Upon selecting content item of an image, the selection indicator in form of a full circle with a check mark 330 is shown within the bottom right part of the image.

### Click-to-Collect Selection

Some embodiments are configured to readily (in terms of number of clicks) create an ordered list out of content items from one or more media servers or services (i.e., external resources, which typically provide structured data that is related to other resources). It might be useful for a user to select content items across different resources, which requires the list aggregation server to pull media content from theses external resources, parse and prepare the results, and then include the results of the parsed and prepared content items into a single media content list. In some embodiments, this list is displayed on the UI in combination with a selection indicator for each item. Clicking the selection indicator selects the corresponding content item to be included in a collection. The order, in which selection indicators of the content items are clicked, is the order that the selected content items are appended to the collection. In some embodiments, clicking a “Finish” button results in the collection of content items to be stored in the media collection store. In terms of UI interactions (number of clicks) these embodiments require only a single click by the user for each of the content items to be selected in addition to a single final click to store this collection with the selected content items in the order that these items are clicked.

FIG. 3C illustrates a media content list 230 based on a user specifying a filter criteria for the content items that are to be included in the media content list, according to some embodiments. Only content items satisfying the filter criteria are included in the media content list 230 and displayed through the UI 220 on the client device. A user may specify a filter criteria based on the text string, e.g. “#burningman.” Only content items containing this text string are then included in the media content list 230 shown through the UI on the client device.

FIG. 3D illustrates a media content list 230 that allows for the user to select the order in which the content items are placed in the collection as indicated by a number displayed in a circle 360 for each content item, according to some embodiments. This embodiment is configured to change the order by unselecting and then reselecting content items in a different order. Once the content item is selected, the collection is assembled in one click by the user with the media content application 195 communicating the collection to the list aggregation server 150.

Authentication with External Sources

FIG. 4 illustrates a flow diagram for authenticating a media server or service 120 with the media content aggregation system 130, according to some embodiments. In some embodiments, the media content application 195 queries the user of the client device 110 to permit the aggregation system 130 access to a particular media server or service, e.g. FACEBOOK. In response to the user permitting such access, the media content application 195 sends a request to the API server 190 associated with the media server or service 120 using APIs provided by the API server 190 to determine if the user has an account with the media server or service. Upon returning the request that the user has an account with the media server or service, the media content application 195 queries the user to input authentication information for the media server or service 120.

In some embodiments, the request labelled “Requests Permission #2” in FIG. 4 is presented to the user, e.g., through a pop-up window in the UI 220, on the client device 110 that allows the user to input the authentication information, for example, a username and password. The interface presented to the user on the client device 110 can be a popup window. In some embodiments, the user interface presented to the user displays information to the user indicating that the user is logging into the media server or service.

The media content application 195 then sends the inputted authentication information to the API server 190 and requests permission to access to the user's media content provided by the media server or service 120. The request may be an API call to the API server 190. If the user provides the correct authentication information and the API server 190 successfully authenticates the user based on this information, the user is logged into the media server or service 120. If the user successfully logs into the media server or service 120, the API server 190 returns an authentication token to the media content application 195. The authentication token is then locally cached on the client. In an alternative embodiment, the authentication token is stored in the media content list store 160 by the list aggregation server 150, after the token is received by the list aggregation server 150 from the API server 190 or communicated by the media content application 195 to the list aggregation server 150.

In some embodiments, the media content application 195 queries the media content list store 160 for an authentication token to a particular media server or service, e.g. FACEBOOK. If the authentication token is present, the media content application 195 presents an interface to the user indicating that the media content aggregation system 130 has access to the media server or service and an option to retrieve media content from the media server or service. Upon the user confirming to retrieve this media content, the media content application 195 communicates the authentication token to the API server 190 to retrieve the requested media content. If the authentication token successfully authenticates the user with the API server 190, the API server sends the requested media content to the list aggregation server 150.

In some embodiments, before querying a user to input authentication information the media content application 195 retrieves an authentication token associated with a media server or service from media content list store 160. If the authentication token is retrieved by the media content application, the media content application presents an interface to the user indicating an option to retrieve media content from the media server or service. Upon the user confirming to retrieve this media content, the media content application 195 communicates the authentication token to the API server 190 to retrieve the requested media content. If the authentication token successfully authenticates the user with the API server, the API server 190 may send an updated authentication token to the media content application 195. The media content application 195 stores the updated token either in the media content list store by communicating the token to the list aggregation server 150.

In some embodiments, the media content aggregation system 130 provides an authentication token of a user to a media server or service 120 to gain access to the media content stored on the server's media content store 180 and associated with the user. Associating the server-stored content with a unique authentication token allows the media server or service to retrieve a particular user's content from data stored for a plurality of users. In turn, the media content aggregation system 130 can have several users interact with a media server or service by associating each stored authentication token with its particular user.

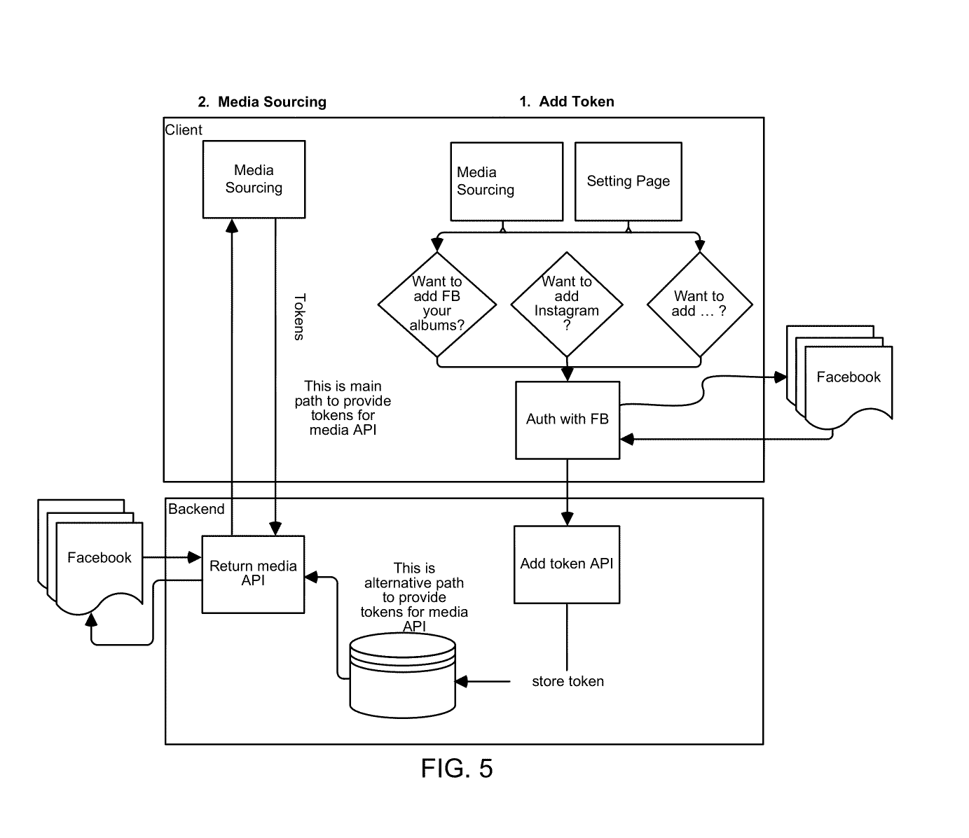

FIG. 5 illustrates a flow diagram of an alternative embodiment for authenticating a media server or service with the media content aggregation system 130 and retrieving media content from the media server or service with the authentication handled by the list aggregation server 150. In this embodiment, the user does not have to authenticate with different media servers or services each time when generating a media content list. Initially, the user provides authentication information that is required to authenticate and to grant access to a particular media server or service. The list aggregation server is configured to handle different authentication mechanisms and protocols to access media content and other data from the different media server or services. The list aggregation server may store the required authentication information provided by the user to access the media server or service. In addition, the list aggregation server may store authentication tokens and session information that are provided by the media server or service after a first successful authentication to avoid additional request for authentication information directed to the user. Examples of authentication mechanisms include OpenID (explained at http://en.wikipedia.org/wiki/OpenID and incorporated herein by reference). In this example, the user first logs in into the target media server or service, and upon successful login the client device used by the user for logging into the media server or service receives an authentication token. In some embodiments, this token is used by the list aggregation server 150 to login to the particular media server or service 120 without the need to obtain access to the authentication information such as a user password. The list aggregation server stores a user's authentication token for later use in the media content list store and associates the token with a particular user and media server or service.

### Computing Machine Architecture

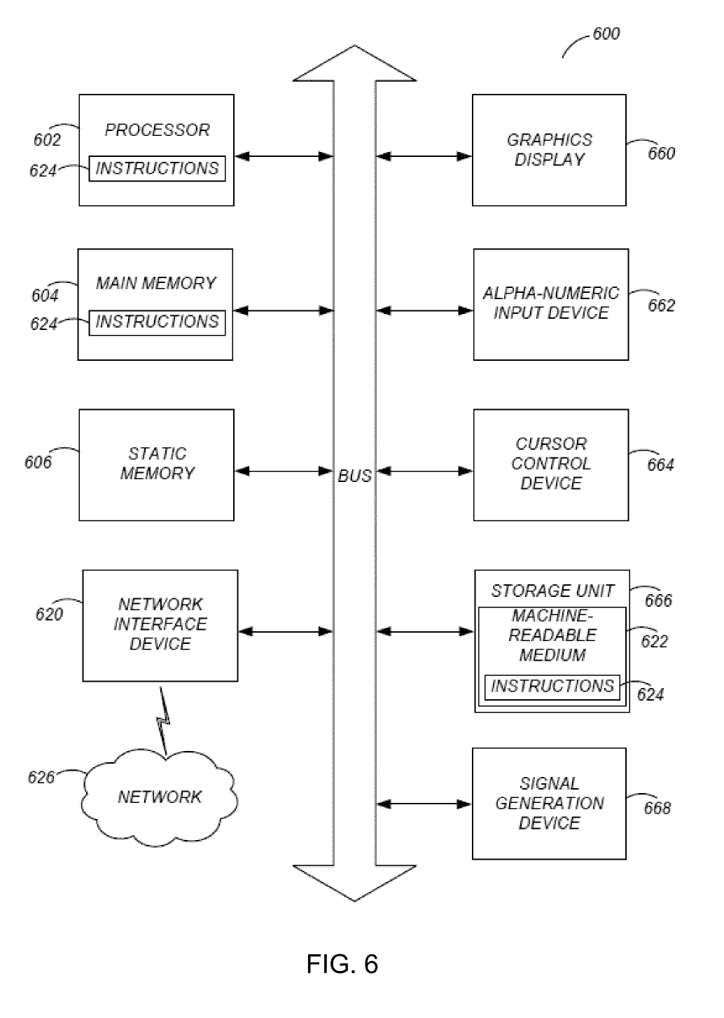

FIG. 6 is a block diagram illustrating components of an example machine able to read instructions from a machine-readable medium and execute them in a processor (or controller). Specifically, FIG. 6 shows a diagrammatic representation of a machine in the example form of a computer system 600 within which instructions 624 (e.g., software) for causing the machine to perform any one or more of the methodologies discussed herein may be executed. In alternative embodiments, the machine operates as a standalone device or may be connected (e.g., networked) to other machines. In a networked deployment, the machine may operate in the capacity of a server machine or a client machine in a server-client network environment, or as a peer machine in a peer-to-peer (or distributed) network environment.

The machine may be a server computer, a client computer, a personal computer (PC), a tablet PC, a set-top box (STB), a personal digital assistant (PDA), a cellular telephone, a smartphone, a web appliance, a network router, switch or bridge, or any machine capable of executing instructions 624 (sequential or otherwise) that specify actions to be taken by that machine. Further, while only a single machine is illustrated, the term “machine” shall also be taken to include any collection of machines that individually or jointly execute instructions 624 to perform any one or more of the methodologies discussed herein.

The example computer system 600 includes a processor 602 (e.g., a central processing unit (CPU), a graphics processing unit (GPU), a digital signal processor (DSP), one or more application specific integrated circuits (ASICs), one or more radio-frequency integrated circuits (RFICs), or any combination of these), a main memory 604, and a static memory 606, which are configured to communicate with each other via a bus 608. The computer system 600 may further include graphics display unit 660 (e.g., a plasma display panel (PDP), a liquid crystal display (LCD), a projector, or a cathode ray tube (CRT)). The computer system 600 may also include alphanumeric input device 662 (e.g., a keyboard), a cursor control device 664 (e.g., a mouse, a trackball, a joystick, a motion sensor, or other pointing instrument), a storage unit 666, a signal generation device 668 (e.g., a speaker), and a network interface device 620, which also are configured to communicate via the bus 608.

The storage unit 666 includes a machine-readable medium 622 on which is stored instructions 624 (e.g., software) embodying any one or more of the methodologies or functions described herein. The instructions 624 (e.g., software) may also reside, completely or at least partially, within the main memory 604 or within the processor 602 (e.g., within a processor's cache memory) during execution thereof by the computer system 600, the main memory 604 and the processor 602 also constituting machine-readable media. The instructions 624 (e.g., software) may be transmitted or received over a network 626 via the network interface device 620.

While machine-readable medium 622 is shown in an example embodiment to be a single medium, the term “machine-readable medium” should be taken to include a single medium or multiple media (e.g., a centralized or distributed database, or associated caches and servers) able to store instructions (e.g., instructions 624). The term “machine-readable medium” shall also be taken to include any medium that is capable of storing instructions (e.g., instructions 624) for execution by the machine and that cause the machine to perform any one or more of the methodologies disclosed herein. The term “machine-readable medium” includes, but not be limited to, data repositories in the form of solid-state memories, optical media, and magnetic media.

### Alternative Applications

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure.

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments of the invention may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a tangible computer readable storage medium or any type of media suitable for storing electronic instructions, and coupled to a computer system bus. Furthermore, any computing systems referred to in the specification may include a single processor or may be architectures employing multiple processor designs for increased computing capability.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., application program interfaces (APIs).)

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Some portions of this specification are presented in terms of algorithms or symbolic representations of operations on data stored as bits or binary digital signals within a machine memory (e.g., a computer memory). These algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the invention. This description should be read to include one or at least one and the singular also includes the plural unless it is obvious that it is meant otherwise. Embodiments of the invention may also relate to a computer data signal embodied in a carrier wave, where the computer data signal includes any embodiment of a computer program product or other data combination described herein. The computer data signal is a product that is presented in a tangible medium or carrier wave and modulated or otherwise encoded in the carrier wave, which is tangible, and transmitted according to any suitable transmission method.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed is:

1. A computer-implemented method for aggregating a user's content items from a plurality of media content servers into an ordered and formatted media collection, the method comprising:
receiving a plurality of content items from a plurality of media content servers;
filtering content items based on user-defined filter criteria;
combining the filtered content items into a media content list;
displaying the media content list for selecting one or more content items of the media content list;
selecting one or more content items form the displayed media content list;
generating a media collection including the one or more selected content items; and
formatting the media collection for displaying on one or more user-defined electronic devices.

2. The computer-implemented method of claim 1, further comprising:
storing the formatted media collection in a media collection database.

3. The computer-implemented method of claim 1, wherein the combining of the filtered content items into a media content list comprises formatting the media content list for displaying on one or more user-defined electronic devices.

4. The computer-implemented method of claim 3, wherein the formatting of the media content list comprises ordering the content items included in the media content list based on user-specified preferences.

5. The computer-implemented method of claim 1, wherein a content item of the plurality of content items comprises machine-readable data, a text message, an image, a digital audio, a digital video, an electronic document, a content title, a headline, a description of content, content location information, metadata, geographic location information, user identity, time and date of content creation, time and date of content posting, content tag, or any combination thereof.

6. The computer-implemented method of claim 1, further comprising:
displaying a pre-defined list of media content servers;
selecting the plurality of media content servers from the pre-defined list; and
querying the selected plurality of media content servers for content items.

7. The computer-implemented method of claim 6, further comprising:
listing or unlisting a media content server from the pre-defined list of media content servers.

8. The computer-implemented method of claim 6, wherein the displaying of the list of media content servers comprises:
transmitting an authenticating request to each media content servers included in the pre-defined list of media content servers; and
in response to successful authentication of a media content server based on the transmitted authentication request, querying the authenticated media content server for content items that are associated with the user.

9. The computer-implemented method of claim 1, wherein the selecting one or more content items form the displayed media content list comprises selecting a format for each of the selected one or more content items.

10. The computer-implemented method of claim 9, further comprising:
determining a type of the one or more user-defined electronic devices; and
in response to determining the type of the one or more user-defined electronic devices, displaying format options for selecting the format for each of the selected one or more content items.

11. The computer-implemented method of claim 9, further comprising:
providing a user interface for inputting a plurality of device types; and
in response to inputting a plurality of device types, displaying format options based on inputted plurality of device types for selecting the format for each of the selected one or more content items.

12. The computer-implemented method of claim 1, wherein the user-defined filter criteria comprise a date and time associated with the content items.

13. A computer-implemented method for aggregating a user's content items from a plurality of media servers, the method comprising:
at an electronic device with a display:
receiving a media content list comprising content items, the content items being received from a plurality of media servers and filtered based on a user-defined filter criteria;
displaying the media content list through a user interface for selecting content items from the media content list to create a media collection;
selecting a content item from the media content list in order by clicking on the content item; and
transmitting an ordered selection of content items in response to interacting with the user interface, the ordered selection comprising the selecting content item in the order the content item was selected.

14. The computer-implemented method of claim 13, wherein a content item of the plurality of content items comprises machine-readable data, a text message, an image, a digital audio, a digital video, an electronic document, a content title, a headline, a description of content, content location information, metadata, geographic location information, user identity, time and date of content creation, time and date of content posting, content tag, or any combination thereof.

15. The computer-implemented method of claim 13, wherein the selecting the content item form the displayed media content list comprises selecting a format for the selected content item.

16. The computer-implemented method of claim 15, further comprising:
determining a type of a client device for displaying the ordered selection on the client device's display; and
in response to determining the type, displaying format options for selecting the format for the selected content item.

17. The computer-implemented method of claim 15, further comprising:
providing a user interface for inputting a plurality of device types; and
in response to inputting a plurality of device types, displaying format options based on inputted plurality of device types for selecting the format for the selected content item.

18. The computer-implemented method of claim 13, further comprising:
transmitting an authenticating request to a media content server of the plurality of media content servers; and
in response to successful authentication of the media content server based on the transmitted authentication request, querying the authenticated media content server for content items that are associated with the user.

19. The computer-implemented method of claim 13, wherein the user-defined filter criteria comprise a date and time associated with the content items.

20. A non-transitory computer-readable storage medium including instructions to perform the method of claim 1.
